(19) United States
(12) Patent Application Publication
(10) Pub. No.: US 2021/0021481 A1
(43) Pub. Date: Jan. 21, 2021

(54) SYSTEMS AND METHODS FOR OPTIMIZING CONTINUITY OF OPERATIONS

(71) Applicant: Sin Yan Kitty Ng, Hong Kong (HK)

(72) Inventor: Sin Yan Kitty Ng, Hong Kong (HK)

(21) Appl. No.: 16/513,982

(22) Filed: Jul. 17, 2019

(51) Int. Cl. H04L 12/24

(52) U.S. Cl. CPC H04L 41/147; H04L 67/10; H04L 41/0654

(57) ABSTRACT

The present disclosure relates to systems and methods for providing a MSR solution for a networked computing platform. In one embodiment, a customer or the like can select a Mission-critical service provider from a group (at least one) of Mission-critical service providers using a customer interface to a MSR gateway. Similarly, using the interface and MSR gateway, the customer can then submit a request for MSR to be performed for a set (at least one) of applications. The customer will then also submit (via the interface and MSR gateway) MSR information. This information can include, among other things, a set of software solution images, a set of software solution files, a set of resumption requirements, a designation of one or more specific (e.g., application) components for which MSR is desired.

### FIELD OF THE INVENTION

This invention is generally related to a mission critical service resumption solution for a networked computing platform. Specifically, this invention relates to selecting a mission critical service provider from a group of mission critical service providers using a customer interface to a mission critical service resumption gateway.

### BACKGROUND OF THE DISCLOSED TECHNOLOGY

Currently, Mission-critical service resumption (MSR) tests are relatively inefficient and cumbersome to perform. Along these lines, MSR tests per service often fail MSR threshold requirements such as service Recovery Time Objective (RTO), component RTO, data RTO, and Recovery Point Objective (RPO). As such, it is difficult to gauge the success rate of MSR tests and MSR performance during actual disasters. In general, MSR exercises range from table top exercises, and in-lab partial recovery tests, to full scale MSR site recovery tests. Currently, availability of MSR tests that allow for automated third party recovery tests that focus on specific services and service components is very limited. Given the larger portfolio of Information Technology (IT) enabled business services that large enterprises have and their interdependencies, it is difficult and costly to run full scale MSR drills on a periodic basis. Moreover, the portfolio of Service Oriented Architecture (SOA)/Web services (e.g., atomic composite, and clustered services) and their relationship to business services and business processes introduce more complexity to MSR scenarios and exercises. With the advent of the cloud computing platform technology, an enhancement to the predecessor grid platform, multiple computation resources may be further abstracted by a cloud layer, thus making separate devices appear to an end-consumer as a single group of integrated resources. These resources in the context of MSR may include resumption of services such as physical or logical compute engines, servers and devices, device memory, and storage devices. Providers of such services in the foreseeable future would have enhanced responsibilities in testing the actual serviceability of the underlying cloud providers in view of the different requirements each set out by the customer concerning the expected uptime and maximum allowed downtime when a downtime occurs.

### SUMMARY OF THE INVENTION

The present solution provides a MSR solution for a networked computing platform such as a cloud computing platform. Specifically, a customer or the like can select a Mission-critical service provider from a group (at least one) of Mission-critical service providers using a customer interface to a MSR gateway. Similarly, using the interface and MSR gateway, the customer can then submit a request for MSR to be performed for a set (at least one) of applications. The customer will then also submit (via the interface and MSR gateway) MSR information. This information can include, among other things, a set of software solution images, a set of software solution files, a set of resumption requirements, a designation of one or more specific (e.g., application) components for which MSR is desired, log file(s), data storage file(s), etc. Using the MSR information, the MSR provider will then generate and conduct a set of MSR tests and provide the results to the customer via the MSR gateway and interface. In one embodiment, a interim MSR platform can be created (e.g., by the MSR provider or the customer) in which the MSR tests are conducted.

A first aspect of the present invention provides a method for providing Mission-critical service resumption in a networked computing platform, comprising: receiving a selection of a Mission-critical service provider from a customer, the selection being made from a group of Mission-critical service providers; receiving a request from the customer for Mission-critical service resumption to be performed for a set of applications; receiving Mission-critical service resumption information from the customer pertaining to the request, the Mission-critical service resumption information comprising at least one of the following: a set of software solution images, a set of software solution files, and a set of resumption requirements; providing the Mission-critical service resumption information to the Mission-critical service provider; and receiving results of a set of Mission-critical service resumption tests conducted by the Mission-critical service provider in response to the request, the set of Mission-critical service resumption tests being developed based on the Mission-critical service resumption information.

A second aspect of the present invention provides a system for providing Mission-critical service resumption in a networked computing platform, comprising: a bus; a processor coupled to the bus; and a memory medium coupled to the bus, the memory medium comprising instructions to: receive a selection of a Mission-critical service provider from a customer, the selection being made from a group of Mission-critical service providers; receive a request from the customer for Mission-critical service resumption to be performed for a set of applications; receive Mission-critical service resumption information from the customer pertaining to the request, the Mission-critical service resumption information comprising at least one of the following: a set of software solution images, a set of software solution files, and a set of resumption requirements; provide the Mission-critical service resumption information to the Mission-critical service provider; and receive results of a set of Mission-critical service resumption tests conducted by the Mission-critical service provider in response to the request, the set of Mission-critical service resumption tests being developed based on the Mission-critical service resumption information.

A third aspect of the present invention provides a computer program product for providing Mission-critical service resumption in a networked computing platform, the computer program product comprising a computer readable storage media, and program instructions stored on the computer readable storage media, to: receive a selection of a Mission-critical service provider from a customer, the selection being made from a group of Mission-critical service providers; receive a request from the customer for Mission-critical service resumption to be performed for a set of applications; receive Mission-critical service resumption information from the customer pertaining to the request, the Mission-critical service resumption information comprising at least one of the following: a set of software solution images, a set of software solution files, and a set of resumption requirements; provide the Mission-critical service resumption information to the Mission-critical service provider; and receive results of a set of Mission-critical service resumption tests conducted by the Mission-critical service provider in response to the request, the set of Mission-critical service resumption tests being developed based on the Mission-critical service resumption information.

A fourth aspect of the present invention provides a method for deploying a system for providing Mission-critical service resumption in a networked computing platform, comprising: deploying a computer infrastructure being operable to: receive a selection of a Mission-critical service provider from a customer, the selection being made from a group of Mission-critical service providers; receive a request from the customer for Mission-critical service resumption to be performed for a set of applications; receive Mission-critical service resumption information from the customer pertaining to the request, the Mission-critical service resumption information comprising at least one of the following: a set of software solution images, a set of software solution files, and a set of resumption requirements; provide the Mission-critical service resumption information to the Mission-critical service provider; and receive results of a set of Mission-critical service resumption tests conducted by the Mission-critical service provider in response to the request, the set of Mission-critical service resumption tests being developed based on the Mission-critical service resumption information.

Mission-critical systems are systems that people rely on a daily basis. It is a system that someone somewhere relies on to get something done, without data loss or corruption and without stopping working when they need it to work. When such a system fails to operate, something serious may occur that can disrupt our lives. For example, when a mobile operator system is down, we can't get email, phone, text messages, or maps to get anywhere, sometimes for a few minutes and more serious to hours before the service can resume.

In another example, we rely on financial institutions that provide timely services so that financial transactions like investment or even simple withdrawals can take place in time. Imagine if one tried to transfer money, sell a stock, or buy a mutual fund and was told that such transactions are made impossible because the systems were down, and that is clearly not acceptable. Therefore, it is very important for businesses to know how reliable their systems are when a disruption occurs. In the past, it would be very difficult because each business relies on the internal staff to manage IT systems and it would be unrealistic and difficult to manage the responsiveness of each of the system being managed. With cloud-based infrastructure, each business should manage the expectation of such a matter in a much better way because cloud providers with virtually unlimited resources should be able to manage the reliability aspect of the underlying system in a much better position. With our invention, each business entity would be able to distinguish the different capability of each cloud provider in accordance with the requirements of the business and negotiate a measureable metrics as a form of Service Level Agreement, which can be binding to be committed by the cloud service provider and is able to be tested continuously by simulating test/disruption environment before actual problem or disruption occurs. This allows business entities manage expectation of downtime when a problem occurs and allow them to make business decisions regarding the affordability of the expected downtime of a particular system when a disruption problem or glitch occurs.

### BRIEF DESCRIPTION OF THE DRAWINGS

FIG. 1 shows a schematic example of a cloud computing node, according to an embodiment of the present invention.

FIG. 2 illustrates a cloud computing platform, according to an embodiment of the present invention.

FIG. 3 illustrates a set of functional abstraction layers provided by cloud computing platform of FIG. 2, according to embodiment of an invention.

FIG. 3 shows a set of functional abstraction layers according to at least one embodiment of the present invention.

FIG. 4 shows a component flow diagram showing a customer interface according to at least one embodiment of the present invention.

FIG. 5 shows an illustrative method flow diagram according to an embodiment of the present invention is shown.

### DETAILED DESCRIPTION OF EMBODIMENTS OF THE DISCLOSED TECHNOLOGY

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

Description of the preferred embodiment of the present invention is a mission critical service resumption solution for a networked computing platform that can be best exemplified as a cloud computing platform. Specifically, a customer or the like can select a mission critical service provider from a group of mission critical service providers using a customer interface to a mission critical service resumption gateway. Similarly, using the interface and mission critical service resumption gateway, the customer can then submit a request for mission critical service resumption to be performed for a set of applications. The customer will then also submit via the interface and mission critical service resumption gateway mission critical service resumption information. This information can include, among other things, a set of software solution images, a set of software solution files, a set of resumption requirements, a designation of one or more specific components for which mission critical service resumption is desired, log files, data storage files. Using the mission critical service resumption information, the mission critical service resumption provider will then generate and conduct a set of mission critical service resumption tests and provide the results to the customer via the mission critical service resumption gateway and interface. In one embodiment, an interim mission critical service resumption platform can be created by the mission critical service resumption provider or the customer in which the mission critical service resumption tests are conducted.

It is understood in advance that although this disclosure includes a detailed description of cloud computing, implementation of the teachings recited herein are not limited to a cloud computing platform. Rather, embodiments of the present invention are capable of being implemented in conjunction with any other type of computing platform now known or later developed.

Cloud computing is a model of service delivery for enabling convenient, on-demand network access to a shared group of configurable computing resources such as networks, network bandwidth, servers, processing, memory, storage, applications, virtual machines, and services that can be rapidly provisioned and released with minimal management effort or interaction with a provider of the service. This cloud model may include at least five characteristics, at least three service models, and at least four deployment models.

Characteristics are as follows: On-demand self-service: a cloud consumer can unilaterally provision computing capabilities, such as server time and network storage, as needed, automatically without requiring human interaction with the service's provider. Broad network access: capabilities are available over a network and accessed through standard mechanisms that promote use by heterogeneous thin or thick client platforms including mobile phones, laptops, and PDAs. Resource grouping: the provider's computing resources are grouped to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction including country, state, or datacenter. Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported providing transparency for both the provider and consumer of the utilized service. Service Models are as follows. Software as a service refers to the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited consumer-specific application configuration settings. Platform as a service refers to the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting platform configurations. Infrastructure as a Service refers to the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components such as firewalls.

Deployment Models are as follows. Private cloud refers to the cloud infrastructure that is operated solely for an organization. It may be managed by the organization or a third party and may exist on-premises or off-premises. Community cloud refers to the cloud infrastructure that is shared by several organizations and supports a specific community that has shared concerns (e.g., mission, security requirements, policy, and compliance considerations). It may be managed by the organizations or a third party and may exist on-premises or off-premises. Public cloud refers to the cloud infrastructure that is made available to the general public or a large industry group and is owned by an organization selling cloud services. Hybrid cloud refers to the cloud infrastructure that is a composition of two or more clouds that remain unique entities but are bound together by standardized or proprietary technology that enables data and application portability (e.g., cloud bursting for load-balancing between clouds). A cloud computing platform is service oriented with a focus on statelessness, loose coupling, module driven, and format interoperability. At the heart of cloud computing is an infrastructure comprising a network of interconnected nodes.

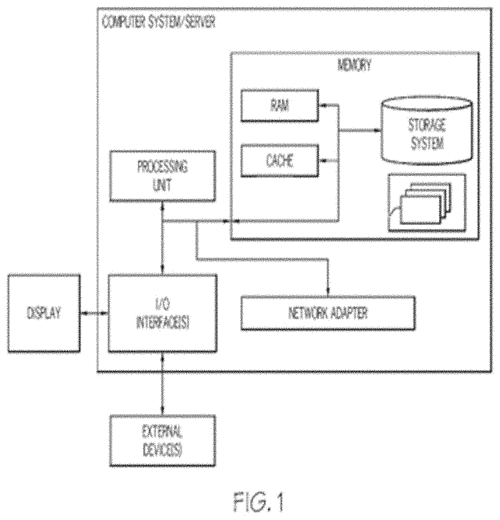

Referring now to FIG. 1, a schematic of an example of a cloud computing node is shown. Cloud computing node is only one example of a suitable cloud computing node and is not intended to suggest any limitation as to the scope of use or functionality of embodiments of the invention described herein. Regardless, cloud computing node is capable of being implemented and/or performing any of the functionality set forth above.

In cloud computing node, there is a computer system/server, which is operational with numerous other general purpose or special purpose computing system platforms or configurations. Examples of well-known computing systems, platforms, and/or configurations that may be suitable for use with computer system/server include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing platforms that include any of the above systems or devices, and the like.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed cloud computing platforms where tasks are performed by remote processing devices that are linked through a communications network. In a distributed cloud computing platform, program modules may be located in both local and remote computer system storage media including memory storage devices.

As shown again in FIG. 1, computer system/server in cloud computing node is shown in the form of a general-purpose computing device. The components of computer system/server may include, but are not limited to, one or more processors or processing units, a system memory, and a bus that couples various system components including system memory to processor.

Bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture bus, Micro Channel Architecture bus, Enhanced ISA bus, Video Electronics Standards Association local bus, and Peripheral Component Interconnects bus.

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory and/or cache memory. Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus by one or more data media interfaces. As will be further depicted and described below, memory may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied. Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency, etc., or any suitable combination of the foregoing. Code includes mission critical service resumption program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking platform. Program modules generally carry out the functions and/or methodologies of embodiments of the invention as described herein.

Computer system/server may also communicate with one or more external devices such as a keyboard, a pointing device, a display, etc.; one or more devices that enable a consumer to interact with computer system/server; and/or any devices (e.g., network card, modem, etc.) that enable computer system/server to communicate with one or more other computing devices. Such communication can occur via I/O interfaces. Still yet, computer system/server can communicate with one or more networks such as a local area network (LAN), a general wide area network (WAN), and/or a public network (e.g., the Internet) via network adapter. As depicted, network adapter communicates with the other components of computer system/server via bus. It should be understood that although not shown, other hardware and/or software components could be used in conjunction with computer system/server. Examples include, but are not limited to: microcode, device drivers, redundant processing units, external disk drive arrays, RAID systems, tape drives, and data archival storage systems, etc.

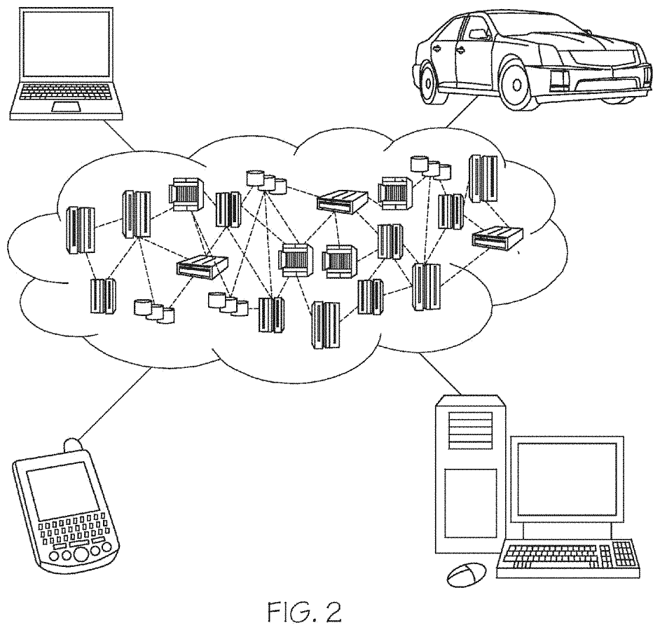

Referring now to FIG. 2, illustrative cloud computing platform is depicted. As shown, cloud computing platform 50 comprises one or more cloud computing nodes with which local computing devices used by cloud consumers, such as, for example, personal digital assistant (PDA) or cellular telephone, desktop computer, laptop computer, and/or automobile computer system may communicate. Nodes may communicate with one another. They may be grouped (not shown) physically or virtually, in one or more networks, such as private, community, public, or hybrid clouds as described hereinabove, or a combination thereof. This allows cloud computing platform to offer infrastructure, platforms, and/or software as services for which a cloud consumer does not need to maintain resources on a local computing device. It is understood that the types of computing devices shown in FIG. 2 are intended to be illustrative only and that computing nodes and cloud computing platform can communicate with any type of computerized device over any type of network and/or network addressable connection (e.g., using a web browser).

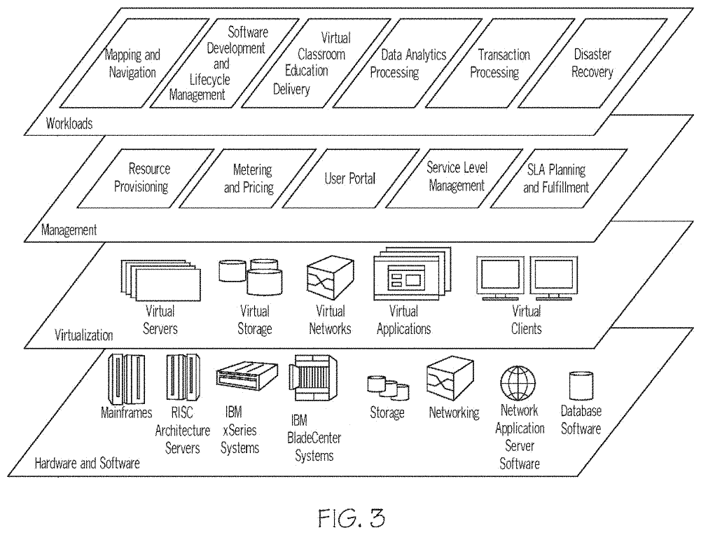

Referring now to FIG. 3, a set of functional abstraction layers provided by cloud computing platform (FIG. 2) is shown. It should be understood in advance that the components, layers, and functions shown in FIG. 3 are intended to be illustrative only and embodiments of the invention are not limited thereto. As depicted, the following layers and corresponding functions are provided: Hardware and software layer includes hardware and software components.

Examples of hardware components include mainframes. In one example, IBM architecture based servers, systems, storage devices, networks, and networking components. Examples of software components include network application server software. Virtualization layer provides an abstraction layer from which the following examples of virtual entities may be provided: virtual servers; virtual storage; virtual networks, including virtual private networks; virtual applications and operating systems; and virtual clients.

In one example, management layer may provide the functions described below. Resource provisioning provides dynamic procurement of computing resources and other resources that are utilized to perform tasks within the cloud computing platform. Metering and pricing provide cost tracking as resources are utilized within the cloud computing platform, and billing or invoicing for consumption of these resources. In one example, these resources may comprise application software licenses. Security provides identity verification for cloud consumers and tasks, as well as protection for data and other resources. Consumer gateway provides access to the cloud computing platform for consumers and system administrators. Service level management provides cloud computing resource allocation and management such that required service levels are met. Service level agreement planning and fulfillment provides pre-arrangement for, and procurement of, cloud computing resources for which a future requirement is anticipated in accordance with an Service level agreement.

Workloads layer provides examples of functionality for which the cloud computing platform may be utilized. Examples of workloads and functions which may be provided from this layer include: mapping and navigation; software development and lifecycle management; virtual classroom education delivery; data analytics processing; transaction processing; and disaster recover. As mentioned above, all of the foregoing examples described with respect to FIG. 3 are illustrative only, and the invention is not limited to these examples.

It is understood all functions of the present invention as described herein are typically performed by the disaster recover function, which can be tangibly embodied as modules of program code of disaster program/utility (FIG. 1). However, this need not be the case. Rather, the functionality recited herein could be carried out/implemented and/or enabled by any of the layers shown in FIG. 3.

It is reiterated that although this disclosure includes a detailed description on cloud computing, implementation of the teachings recited herein are not limited to a cloud computing platform. Rather, the embodiments of the present invention are intended to be implemented with any type of networked computing platform now known or later developed.

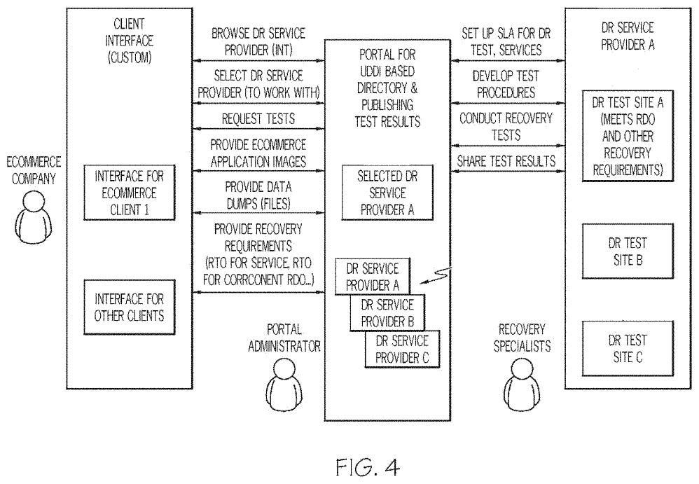

Referring now to FIG. 4, a component flow diagram according to at least one embodiment of the present invention is shown. As depicted, FIG. 4 shows a customer interface operated by a customer/client (e.g., an e-commerce company), a mission critical service resumption gateway operated by a gateway administrator or the like, and a mission critical service resumption Service provider operated by recovery specialists or the like. In general, each customer/client can have their own custom interface (e.g., customized according to their business and/or personal needs). In general, the customer will browse a mission critical service resumption (service) provider group/data storage via mission critical service resumption gateway using interface, and select a mission critical service resumption provider that best suits the customer's needs. mission critical service resumption providers are typically contracted using service level agreements or the like that delineate terms of services. Once a provider is selected, customer will then request mission critical service resumption operations and/or testing to be performed for a set of applications. In addition, customer will also provide mission critical service resumption information for the mission critical service resumption tests to be generated and conducted. mission critical service resumption information can include at least one of the following: a set of software solution images, a set of software solution files, a set of resumption requirements, a designation by the customer of at least one specific component for which mission critical service resumption is needed, a copy of a set of data storages associated with the set of applications; and/or at least one log file associated with the set of applications.

The request and mission critical service resumption information will be routed by mission critical service resumption gateway to the selected mission critical service resumption provider who has the capability of generating and conducting mission critical service resumption tests based on the request and mission critical service resumption information in a mission critical service resumption test platform. In a typical embodiment, a mission critical service resumption test site that can best conduct the mission critical service resumption tests will be selected and/or created by mission critical service resumption provider. Regardless, mission critical service resumption provider will create and conduct a set of mission critical service resumption tests necessary to provide the requested mission critical service resumption in accordance with the mission critical service resumption information. mission critical service resumption test results will then be communicated back to customer via mission critical service resumption gateway and interface. In a typical embodiment, the mission critical service resumption tests can be basic unit and functional tests associated with the recovered application/service component or group of components. In other words, it is determined whether the application or component is functioning as expected in the interim test platform. The mission critical service resumption tests themselves can vary by customer and component, and can be part of the requirement provided by the customer and internally tested by the mission critical service resumption provider and later tested by the customers themselves.

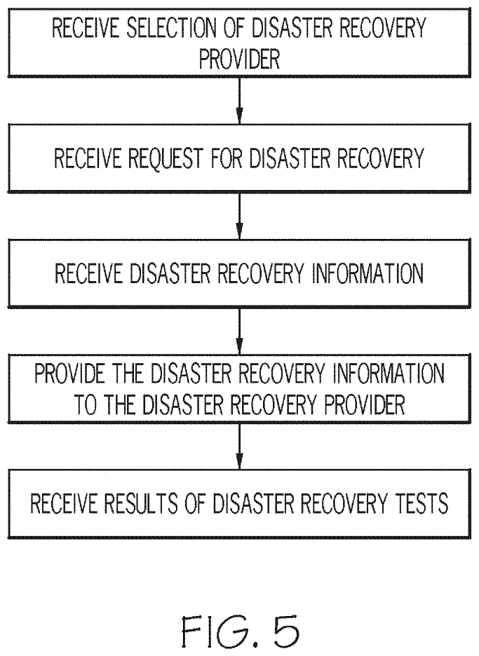

Referring now to FIG. 5, an illustrative method flow diagram according to an embodiment of the present invention is shown. In step S1, a selection of a mission critical service resumption provider is received from a customer. As indicated above, the selection is made from a group of mission critical service resumption providers. In step S2, a request is received from the customer for mission critical service resumption to be performed for a set of applications. In step S3, mission critical service resumption information is received from the customer pertaining to the request. mission critical service resumption information can include at least one of the following: a set of software solution images, a set of software solution files, a set of resumption requirements, a designation by the customer of at least one specific component for which mission critical service resumption is needed, a copy of a set of data storages associated with the set of applications, and/or at least one log file associated with the set of applications. In step S4, the mission critical service resumption information is provided to the mission critical service resumption provider, who will then generate and conduct a set of mission critical service resumption tests based thereon. In step S5, results of the set of mission critical service resumption tests conducted by the mission critical service resumption provider in response to the request are received by the customer via the mission critical service resumption gateway.

While shown and described herein as a mission critical service resumption solution, it is understood that the invention further provides various alternative embodiments. For example, in one embodiment, the invention provides a computer-readable/useable medium that includes computer program code to enable a computer infrastructure to provide mission critical service resumption functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture like a compact disc, a magnetic disk, a tape, etc. on one or more data storage portions of a computing device, such as memory (FIG. 1) and storage system.

In another embodiment, the invention provides a method that performs the process of the invention on a subscription, advertising, and/or fee basis. That is, a service provider, such as a Solution Integrator, could offer to provide mission critical service resumption functionality. In this case, the service provider can create, maintain, support a computer infrastructure, such as computer system (FIG. 1) that performs the processes of the invention for one or more consumers. In return, the service provider can receive payment from the consumers under a subscription and/or fee agreement and/or the service provider can receive payment from the sale of advertising content to one or more third parties.

The foregoing description has been directed to particular embodiments. However, other variations and modifications may be made to the described embodiments, with the attainment of some or all of their advantages. It will be further appreciated by those of ordinary skill in the art that modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

1. A system for providing mission-critical service resumption in a networked computing environment, comprising:
a bus;
a processor coupled to the bus; and
a memory medium coupled to the bus, the memory medium comprising instructions to:
receive a selection of a mission-critical service provider from a customer, the selection being made from a group of mission-critical service providers;
receive a request from the customer for mission-critical service resumption to be performed for a set of applications, the request containing parameters defining recovery point objectives, service recovery time objective, component recovery time object, and data recovery time objective with respect to the set of applications;
receive mission-critical service resumption information from the customer pertaining to the request, the mission-critical service resumption information comprising at least one of the following: a set of software solution images, a set of software solution files, and a set of resumption requirements;
provide the mission-critical service resumption information to the mission-critical service provider; and
receive results of a set of mission-critical service resumption tests conducted by the mission-critical service provider in response to the request, the set of mission-critical service resumption tests being developed based on the mission-critical service resumption information.

2. The system of claim 1, the networked computing environment being a cloud computing environment.

3. The system of claim 2, the selection, the request, the mission-critical service resumption information, and the results being received on a mission-critical service resumption gateway in the networked computing environment.

4. The system of claim 3, the mission-critical service resumption information further comprising a designation by the customer of at least one specific component for which mission-critical service resumption is needed.

5. The system of claim 4, the mission-critical service resumption information further comprising:
a copy of a set of data storages associated with the set of applications; or
at least one log file associated with the set of applications.

6. A method for providing mission-critical service resumption in a networked computing environment, comprising:
receiving a selection of a mission-critical service provider from a customer, the selection being made from a group of mission-critical service providers;
receiving a request from the customer for mission-critical service resumption to be performed for a set of applications, the request containing parameters defining recovery point objectives, service recovery time objective, component recovery time object, and data recovery time objective with respect to the set of applications;
receiving mission-critical service resumption information from the customer pertaining to the request, the mission-critical service resumption information comprising at least one of the following: a set of software solution images, a set of software solution files, and a set of resumption requirements;
providing the mission-critical service resumption information to the mission-critical service provider; and
receiving results of a set of mission-critical service resumption tests conducted by the mission-critical service provider in response to the request, the set of mission-critical service resumption tests being developed based on the mission-critical service resumption information.

7. The method of claim 6, the networked computing environment being a cloud computing environment.

8. The method of claim 7, the selection, the request, the mission-critical service resumption information, and the results being received on a mission-critical service resumption gateway in the networked computing environment.

9. The method of claim 8, the mission-critical service resumption information further comprising a designation by the customer of at least one specific component for which mission-critical service resumption is needed.

10. The method of claim 9, the mission-critical service resumption information further comprising:
a copy of a set of data storages associated with the set of applications; or
at least one log file associated with the set of applications.
